(19) United States
(12) Patent Application Publication
(10) Pub. No.: US 2013/0163877 A1
(43) Pub. Date: Jun. 27, 2013

(54) MIRROR CONTROLLER AND COMPUTER READABLE STORAGE MEDIUM

(71) Applicant: Denso Corporation, Kariya-city (JP)

(72) Inventor: Youji Morishita, Kariya-city (JP)

(73) Assignee: DENSO CORPORATION, Kariya-city (JP)

(21) Appl. No.: 13/706,709

(22) Filed: Dec. 6, 2012

(30) Foreign Application Priority Data
Dec. 26, 2011 (JP) 2011-283894

(51) Int. Cl. G06K 9/00

(52) U.S. Cl. CPC G06K 9/00268
USPC 382/190

(57) ABSTRACT

A mirror controller includes: a face position detector for, analyzing a face image of a driver, and for detecting face position information; an angle calculator for calculating an optimum angle of a mirror of a vehicle according to the face position information so that the driver looks at a predetermined region via the mirror; and a controller for controlling an angle adjuster to adjust the angle of the mirror to be the optimum angle when a driving speed detected by a speed sensor is equal to or smaller than a predetermined threshold value, or when a face direction detected by a face direction detector is different from a direction toward the mirror.

### CROSS REFERENCE TO RELATED APPLICATION

This application is based on Japanese Patent Application No 2011-283894 filed on Dec. 26, 2011, the disclosure of which is incorporated herein by reference.

### TECHNICAL FIELD

The present disclosure relates to a mirror controller and a computer: readable storage medium for controlling an operation of a mirror in a vehicle.

### BACKGROUND

A mirror such as a side mirror and a rearview mirror mounted on a vehicle has an appropriate arrangement angle, which is changeable according to a position of a face of a driver in order to view a backside of the vehicle. Thus, when the driver drives the vehicle, and a posture of the driver is changed, the appropriate angle of the mirror is also changed. It is difficult for the driver to adjust the mirror angle manually when the driver drives the vehicle since the driver can not concentrate on looking around the vehicle. Further, even when the vehicle stops running in case of a red traffic light, the driver may not pay sufficient attention to a situation around the vehicle. And, it is difficult to adjust the mirror to be a best position for the posture of the driver at driving because the driving posture may not be the same as the posture at stopping.

Accordingly, JP-A-2002-274265 teaches a device for controlling a position of the mirror automatically. The device detects a direction of the face of the driver according to shooting images by a camera mounted on the vehicle. Based on the detected direction of the face, the device estimates the frontal position of the face. Based on the estimated frontal position of the face, the device calculates the appropriate mirror angle, and then, the device adjusts the mirror angle.

In the above device, if the driver looks at the mirror while the device is operating to adjust the mirror in order to set the appropriate mirror angle, the driver may misunderstand such that the driver thinks that an object around the vehicle such as another vehicle in the mirror would be moving.

### SUMMARY

It is an object of the present disclosure to provide a mirror controller and a computer readable storage medium for controlling a mirror angle of a mirror in a vehicle in safety according to a driving posture of a driver of a vehicle.

According to an first example aspect of the present disclosure, a mirror controller includes: a face position detector for analyzing an image of a face of a driver in a vehicle, and for detecting face position information, which is indicative of at least one of a position of the face and a position of a part of the face; an angle calculator for calculating an optimum angle of a mirror of the vehicle according to the face position information so that the driver looks at a predetermined region via the mirror with the optimum angle; and a controller for controlling an angle adjuster to adjust the angle of the mirror to be the optimum angle when a driving speed detected by a speed sensor is equal to or smaller than a predetermined threshold value, or when a face direction detected by a face direction detector is different from a direction toward the mirror.

In the above controller, since the angle of the mirror is changed when the driving speed is equal to or smaller than the Predetermined threshold value, or when the face direction is different from the direction toward the mirror, the controller adjusts the mirror in accordance with the driving posture Of the driver in safety.

According to a second example aspect of the present disclosure, a computer readable storage medium storing a program for causing a computer to execute a process includes: providing the face position detector, the angle calculator and the controller, which provide the mirror controller according to the first example aspect of the present disclosure.

In the above medium, since the angle of the mirror is changed when the riving speed is equal to or smaller than the predetermined threshold value, or when the face direction is different from the direction toward the mirror, the controller adjusts the mirror in accordance with the driving posture of the driver in safety.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a block diagram showing a mirror control system;

FIG. 2 is a diagram showing an arrangement of the mirror control system in a compartment of a vehicle;

FIG. 3 is a block diagram showing function blocks in a mirror control ECU;

FIG. 4 is a flowchart showing a procedure of a mirror control process; and

FIG. 5 is a diagram showing a calculation process for calculating an optimum mirror angle.

### DETAILED DESCRIPTION

An example embodiment of the present disclosure will be explained with reference to the drawings.

(1) Construction of a Mirror Control System

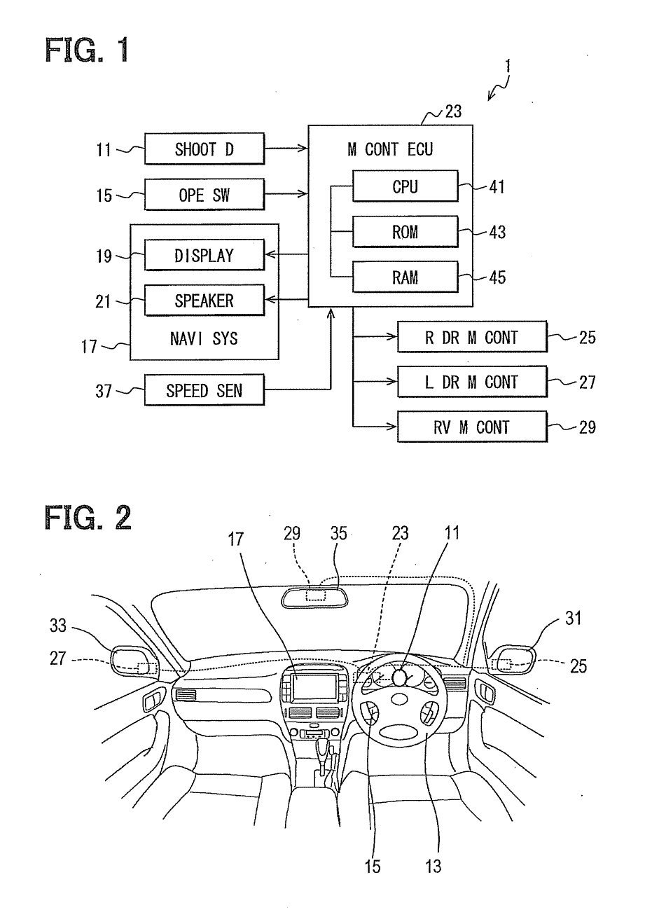

FIG. 1 is a block diagram showing the mirror control system according to the example embodiment. FIG. 2 shows an arrangement of the mirror control system in a compartment of a vehicle.

The mirror control system 1 controls the angle of the mirror with monitoring a Position of a face of a driver so that the driver can drive the vehicle in safety and with comfort.

In the above embodiment, the mirror control system 1 includes a shooting device 11, an operations witch 15 mounted on a steering wheel 13, a display 19 and a speaker 21 assembled as a part of a vehicle navigation system 17, a mirror control ECU (electric control unit) 23, a right door. mirror (i.e., right side mirror) controller 25, a left door mirror a left side mirror) controller 27 and a rearview mirror controller 29.

The shooting device 11 is a well known shooting device for shooting an image including a face of the driver with using a shooting element. For example, the shooting device is a camera having a CCD or a CMOS as the shooting element, an optical lens, an optical filter, an electric circuit such as a power source and the like. The shooting device 11 is arranged at a certain position so that the face of the driver is positioned within a shooting range of the shooting device 11. The shooting device 11 may be an infrared light camera. In this case, the shooting device 11 may include a light emitting device for emitting a near infrared light toward the face of the driven The shooting device 11 shoots an image at every predetermined time interval such as one-thirty second. Then, the shooting device 11 outputs a shot image to the mirror control ECU 23.

In the mirror control process, a user inputs an instruction for permitting a change with using the operation switch 15 when an optimum angle of each mirror is changed. Here, the mirror includes a right side mirror 31, a left side mirror 33 and a rearview mirror 35.

The display 19 and the speaker 21 informs the driver of the change of the optimum angle of each mirror in the mirror control process according to a control signal from the mirror control ECU 23.

The mirror control ECU 23 is a conventional micro computer having a CPU 41, a ROM 43, a RAM 45 and the like. Based on a program stored in the ROM 43, the ECU 23 executes the mirror control process. Further, the ECU 23 receives a signal indicative of a driving speed of the vehicle from a vehicle speed sensor 37, which detects the driving speed of the vehicle.

The right side mirror controller. (i.e., right door mirror controller) 25 includes an actuator for adjusting the mirror angle of the right side mirror 31. The controller 25 adjusts the mirror angle according to the control signal from the ECU 23.

The left side mirror. controller (i.e., left door mirror controller) 27 includes an actuator for adjusting the mirror angle of the left side mirror 33. The controller 27 adjusts the mirror angle according to the control signal from the ECU 23. Further, the rearview mirror controller 29 includes an actuator for adjusting the mirror angle of the rearview mirror 35. The controller 29 adjusts the mirror angle according to the control signal from the ECU 23.

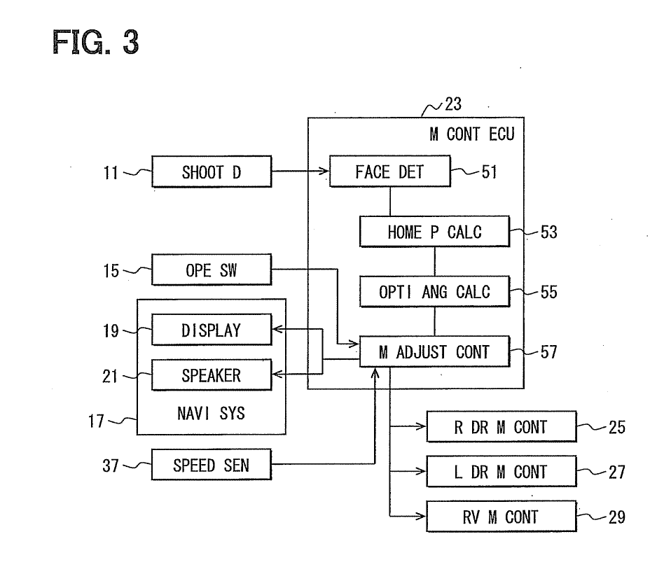

FIG. 3 shows a function of the mirror control ECU 23.

The ECU 23 includes a face detector 51, a home position calculator 53, a optimum mirror angle calculator 55, a mirror adjustment controller 57 and the like. The face detector 51 corresponds to a face position detecting device and a face direction detecting device. The home position calculator 53 corresponds to a position calculating device. The optimum mirror angle calculator 55 corresponds to an angle calculating device. The mirror adjustment controller 57 corresponds to a controlling device.

The face detector 51 analyzes an image obtained by the shooting device 11 so that the face detector 51 detects the position of the face and a certain part of the face of the driver. Specifically, the detector 51 detects the position of the face of the driver in the image. Then, the detector 51 detects the certain part of the face, which is indicative of three dimensional coordinates of a characteristic point of the face, according to the detected position of the face. At the same time, the detector 51 detects the face direction, toward which the face of the driver turns. The detector 51 detects the above information at predetermined time intervals. Then, the detector 51 outputs a signal corresponding to the above information to the ECU 23.

The characteristic point of the face is, for example, an eye, a nose and the like. Alternatively, the characteristic point may be a center position or a gravity center position of the face instead of the part of the face. The position of the face and the three dimensional coordinates of the characteristic point correspond to the information about the position of the face.

According to the image analysis, the position of the face, the part of the face, and the face direction of the driver may be detected by a conventional method. Alternatively, two shot images shot by two cameras arranged at different points may be analyzed so that the position of the face and the three dimensional coordinates of the characteristic point are obtained. Specifically, in this case, the mirror control system 1 includes two shooting devices 11.

A conventional method for detecting the position of the face, the part of the face and the face direction of the driver with using the image analysis process is disclosed in, fore example, JP-A-2008-13023, JP-A-2005-66023, JP-A-2002-352228, JP-A-2007-249280, and JP-A-2005-182452.

The home position calculator 53 calculates a home position according to the records of the position of the face and the part of the face, which are detected by the face detector 51 during a predetermined time interval. Here, the home position represents positional information about an average of the position of the face and an average of the part of the face during a predetermined time interval. In the present embodiment, the home position is three dimensional coordinates of an average position of the eye of the driver.

The optimum mirror angle calculator 55 calculates the optimum angle of the mirror with respect to the home position calculated by the home position calculator 53. The optimum angle provides a preferable angle of the mirror for the driver to see a certain region via the mirror. The optimum angle is determined according to the home position.

The mirror adjustment controller 57 determines whether a predetermined condition for changing the mirror angle is satisfied. When the predetermined condition is met, the mirror adjustment controller 57 outputs the control signal to the right side mirror controller 25, the left side mirror controller 27 and the rearview mirror controller 29 so that the mirror angle is set to be the optimum mirror angle, which is calculated by the optimum mirror angle calculator 55.

(2) Process Executed by Mirror Control ECU

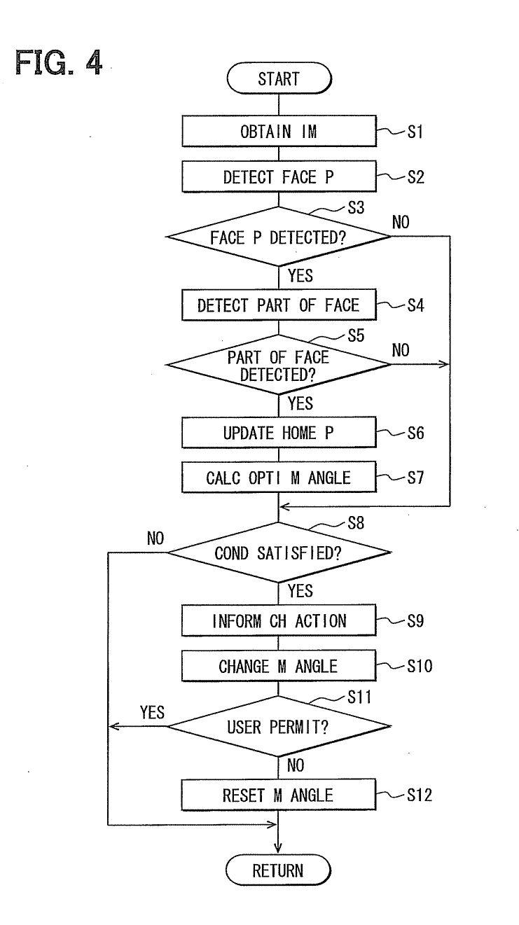

The mirror control process executed by the mirror control ECU 23 will be explained with reference to the flowchart in FIG. 4.

The ECU 23 starts to execute the mirror control process when the ECU 23 is energized, i.e., in the present embodiment, when an ignition switch of the vehicle turns on.

In the present process, in step S1, the ECU 23 obtains an image shot by the shooting device 11.

Then, in step S2, the ECU 23 detects the position of the face according to the image obtained in step S1. The ECU 23 determines in step S3 whether the position of the face is successfully obtained. When the position of the face is not obtained, i.e., when the determination in step S3 is “NO,” it goes to step S8. When the position of the face is successfully obtained, i.e., when the determination in step S3 is “YES,” it goes to step S4. In step S4, the ECU 23 detects the part of the face. Here, the ECU 23 detects the three dimensional coordinates of the position of the eye of the driver.

In step S5, the ECU 23 determines whether the part of the face is successfully detected. When the part of the face is not successfully detected, i.e., when the determination in step S5 is “NO,” it goes to step S8. When the part of the face is successfully detected, i.e., when the determination in step S5 is “YES,” it goes to step S6.

Then, in step S6, the ECU 23 updates the home position. The update of the home position is performed by one of following three methods (i) to (iii). In the following three methods, the home position is calculated by averaging the coordinates of the part of the face, which are obtained from images shot by the shooting device 11 during a predetermined time interval. In this case, the number of images during the predetermined time interval is defined as the predetermined number of image frames. The image frames having the predetermined number are obtained during the predetermined time interval in chronological order. The face of the driver is shot from the earliest shooting time of the image frame to the latest shooting time of the image frame. Accordingly, when the part of the face in the images is averaged, the average position of the part of the face of the driver is calculated. The time interval range for calculating the average of the images, i.e., the number of image frames is determined appropriately.

(i) Simple Moving Average

In a simple moving average method, the coordinates of the part of the face obtained from the image frames having the predetermined number are simply averaged, so that the home position is calculated. Specifically, the simple moving average is calculated by the following equation.

H(t)=Σ_{i=0-N} D(t+i−N)×W

W=1/(1+N)

Here, the variable numbers in the above equation are defined as follows. Further, the definitions of the variable numbers are the same in the following equations.

The variable number “t” represents the frame number, which corresponds to the time. The variable number “N” represents the number of frames when the home position is calculated. The variable number “D(t)” represents the part of the face detected at time t, or the part of the face detected from the image having the frame number t. The variable number “H(t)” represents the home position calculated at time t. The variable number “W” represents the weighting factor.

The above calculation result may be comparatively affected by the displacement of the driver when the driver moves. Thus, the home position may be easily updated to a state such that the home position is arranged on a side of the position after the driver moves. Specifically, the above calculation method is preferable for a case where the system requests to change the home position sensitively.

(ii) Weighted Moving Average

The coordinates of the part of the face obtained from the image frames having the predetermined number are weighted and averaged, so that the home position is calculated. Specifically, the weighted moving average is calculated by the following equation.

H(t)=Σ_{i=0-N} D(t+i−N)×W(i)

W(i)=w (i=N)

(1−w)/N (i≠N)

The moving amount of the home position is adjusted by the variable number “w(0.0 to 1.0).” When the variable number “w” is large, the influence on the current position of the face becomes large. Thus, when the current position of the face is largely displaced from the home position before the home position is updated, the moving amount from the home position before the home position is updated becomes large. On the other hand, when the variable number “w” is small the influence on the current position of the face becomes small.

(iii) Exponential Moving Average

The new home position is calculated by weighting and adding the position of the part of the face newly obtained from the frame and the home position calculated previously. Specifically, the exponential moving average is calculated by the following equation.

H(t)=H(t−1)×(1−W)+D(t)×W

Similar to the above case (ii), when the variable number “W” is large, the influence on the current position of the face becomes large.

Here, in the above described weighted moving average method, the home position is calculated with using only the N-th frame, which is the latest frame. Thus, the home position is comparatively sensitively updated to be the position according to the current position of the face. When the position of the face is positioned apart from the driving posture for a long time since the driver looks both ways, for example, the home position may be varied from the original position of the face of the driver in the driving posture.

In case of the exponential moving average method, even when the current position of the face is displaced from the previous home position since the driver changes the driving posture, the home position is not quickly updated to be a position corresponding to the current position of the face. However, since total information obtained by the detection of the position of the face is taken into account, the influence of the noise generated when the driver looks both ways, for example, is small.

Thus, the home position is updated by one of the above methods. Alternatively, the home position may be updated by another method.

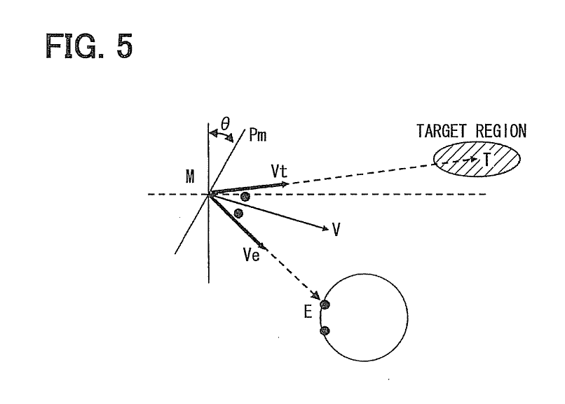

Next, in step S7, the ECU 23 calculates the optimum mirror angle. An example of the calculation method will be explained with reference to FIG. 5. In FIG. 5, M represents a mirror center, E represents a position of the eye, and T represents a center of the target region. The mirror center M, the eye position E and the target region center T are three-dimensional positions. The mirror center M is determined by the position of the mirror. The eye position E is the home position. The target region is a region, which the driver should visually check through the mirror. The target region may be preliminary determined. Alternatively, the driver may set the target region manually.

The mirror angle θ is calculated such that an angle bisector V between a unit vector Ve from the mirror center M to the eye position E and a unit Vector Vt from the mirror center M to the target region center T is equal to a normal vector of the mirror surface Pm. The mirror may be displaced around two axes. Each vector is defined as follows.

Ve=(M−E)/|M−E|

Vt=(M−T)/|M−T|

V=(Ve+Vt)/2

Here, the eye position E may be a position of one of eyes. Alternatively, the eye position E may be an average of two positions of the eyes.

Next, in step. S8, the ECU 23 determines whether a mirror angle changing condition is satisfied. The mirror angle changing condition includes one of the following conditions (A) and (B).

(A) The vehicle stops running. The stoppage of the vehicle is determined based on, for example, the output from the vehicle speed sensor 37.

(B) The face direction of the driver is different from a direction to the mirror.

In addition to the above conditions, another condition that a difference between the latest updated home position and a home position corresponding to the current mirror angle is larger than a predetermined threshold value may be added. In this case, the ECU 23 may determine whether the difference exceeds the predetermined threshold value after a predetermined measurement interval such as ten minutes has elapsed.

When the mirror angle changing condition is not satisfied, i.e., when the determination in step S8 is “NO,” it returns to step S1.

When the mirror angle changing condition is satisfied, i.e., when the determination in step S8 is “YES,” it returns to step S9. In step S9, the ECU 23 informs the driver of a changing action of the mirror angle. Specifically, the ECU 23 controls the display 19 to display a message “a mirror angle will be changed” and another message “please operate an operation switch 15 mounted on a steering wheel 13 when a driver permits to change the mirror angle.” Further, the ECU 23 controls the speaker 21 to output the above voice messages. Alternatively, the mirror control system 1 may further include a LED for emitting light or blinking on and off in order to inform the changing action.

Next, in step S10, the ECU 23 changes the mirror angle according to the new home position.

Next, in step S11, the ECU 23 determines whether the driver performs the permission operation, i.e., the system receives the permission operation from the driver. When the driver operates the operation switch 15, i.e., when the determination in step S11 is “YES,” it returns to step S1 without resetting the mirror angle. On the other hand, when the driver does not operate the operation switch 15 for a predetermined time interval such as five seconds, i.e., when the determination of step S11 is “NO,” it goes to step S12. In step S12, since a difficulty of the angle of the mirror changed in step S10 may arise, the angle of the mirror is reset to an angle before being changed. Then, it returns to step S1.

(3) Effects

In the mirror control system 1 according to the present embodiment, the mirror angle is changed when the vehicle stops running, or when the driver does not look at the mirror. Thus, the mirror angle is adjusted according to the driving posture of the driver in safety. Further, since the home position is calculated from the average of the position of the part of the face obtained from the images shot for a predetermined time interval, the mirror angle is appropriately adjusted, and the influence of the action, which the driver incidentally performs, is small.

In the system 1, when the driver considers that the mirror angle after changing is not appropriate, the system returns the mirror angle to a previous angle. Thus, the driver can drive the vehicle comfortable.

(Modifications)

In the above embodiment, after the mirror angle is changed in step S10, the system requires the driver to input the permission operation via the switch 15. Alternatively, after the driver inputs the permission operation via the switch 15, the system may change the mirror angle. In this case, in step S9, the system outputs a message “when the driver requests to change the mirror angle, please input the permission operation via the operation switch 15.”

In the above described system, when the driver considers that it is not necessary to change the mirror angle, the system does not change the mirror angle. Thus, the driver continues to drive the vehicle comfortably. In the above case, alternatively, the system may request the driver to input the rejection operation via the switch 15 when the driver rejects to change the mirror angle. In this case, the system outputs the message “if the driver rejects to change the mirror angle, please input a rejection operation via the operation switch 15.” When the driver inputs the rejection operation via the switch 15, the system does not change the mirror angle. Instead, when the driver does not input the rejection operation via the switch 15 for a predetermined time interval, the system changes the mirror angle.

In the above embodiment, when the driver operates the operation switch 15 to permit the mirror angle change, the system confirms the changed mirror angle. Alternatively, When the driver rejects to change the mirror angle, the system may request the driver to operate the switch 15.

In the above embodiment, the system 1 includes the display 19 and the speaker 21. Alternatively, the system may not inform the message and the voice message.

In the above embodiment, the changing condition of the mirror angle includes one condition such that the vehicle stops running. Alternatively, the changing condition of the mirror angle may include one condition such that the vehicle speed is equal to or smaller than a predetermined threshold.

In the above embodiment, the home position is calculated with using the part of the face such as an eye. Alternatively, the system may not detect the characteristic point of the face, but the system may calculate the home position with using the position of the face.

The above disclosure has the following aspects.

According to an first example aspect of the present disclosure, a mirror controller includes: a face position detector for analyzing an image of a face of a driver in a vehicle, and for detecting face position information, which is indicative of at least one of a position of the face and a position of a part of the face; an angle calculator for calculating an optimum angle of a mirror of the vehicle according to the face position information so that the driver looks at a predetermined region via the mirror with the optimum angle; and a controller for controlling an angle adjuster to adjust the angle of the mirror to be the optimum angle when a driving speed detected by a speed sensor is equal to or smaller than a predetermined threshold value, or when a face direction detected by. a face direction detector is different from a direction toward the mirror.

In the above controller, the face direction detector may detect the face direction according to the face position information. Since the angle of the mirror is changed when the riving speed is equal to or smaller than the predetermined threshold value, or when the face direction is different from the direction toward the mirror, the controller adjusts the mirror in accordance with the driving posture of the driver in safety. In addition to these conditions, the angle of the mirror may be changed when a difference between the current angle of the mirror and the optimum angle exceeds a predetermined threshold, or when a predetermine time has elapsed since the controller adjusted the mirror previously.

Alternatively, the mirror controller may further include: a position calculator for calculating an average of the face position information according to a record of the face position information, which is obtained in a predetermined time interval. The angle calculator calculates the optimum angel of the mirror according to the average of the face position information. In this case, since the face position information is averaged in the predetermined time interval. The influence of the action, which the driver incidentally performs, is small.

Alternatively, after the angle adjuster adjusts the angle of the mirror to be the optimum angle, the controller may control the angle adjuster to adjust the angle of the mirror to be an previous angle when an input device for inputting at least one of a permission instruction of the optimum angle of the mirror and a rejection instruction of the optimum angle of the mirror does not input the permission instruction, or inputs the rejection instruction. In this case, when the driver considers that the mirror angle after adjustment is not appropriate, the controller returns the mirror angle to the previous angle. Thus, the driver can drive the vehicle comfortable.

Alternatively, the controller may control the angle adjuster to adjust the angle of the mirror to be the optimum angle when an input device for inputting at least one of a permission instruction of the optimum angle of the mirror and a rejection instruction of the optimum angle of the mirror inputs the permission instruction, or does not input the rejection instruction. In this case, when the driver considers that it is not necessary to change the mirror angle, the controller does not change the mirror angle. Thus, the driver continues to drive the vehicle comfortably.

According to a second example aspect of the present disclosure, a computer readable storage medium storing a program for causing a computer to execute a process includes: providing the face position detector, the angle calculator and the controller, which provide the mirror controller according to the first example aspect of the present disclosure. In the above computer readable storage medium, the program provides instructions, which are preferable for the computer to execute the instructions in a certain order. The program is used in the mirror controller through a storage medium or a communication line.

Alternatively, the previous angle of the mirror may be referred to an angle just before the angle adjuster adjusts the angle of the mirror to be the optimum angle. The part of the face is a characteristic point of the face.

Alternatively, the mirror controller may further include: a position calculator for calculating an average of the face position information according to a record of the face position information, which is obtained in a predetermined time interval. The angle calculator calculates the optimum angel of the mirror according to the average of the face position information, and the average of the face position information is calculated by one of simple moving average, weighted moving average and exponential moving average.

Alternatively, the characteristic point of the face may be an eye or a nose of the face, and the mirror may be at least one of a right side mirror, a left side mirror and a rearview mirror of the vehicle.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

What is claimed is:

1. A mirror controller comprising:
a face position detector for analyzing an image of a face of a driver in a vehicle, and for detecting face position information, which is indicative of at least one of a position of the face and a position of a part of the face;
an angle calculator for calculating an optimum angle of a mirror of the vehicle according to the face position information so that the driver looks at a predetermined region via the mirror with the optimum angle; and
a controller for controlling an angle adjuster to adjust the angle of the mirror to be the optimum angle when a driving speed detected by a speed sensor is equal to or smaller than a predetermined threshold value, or when a face direction detected by a face direction detector is different from a direction toward the mirror.

2. The mirror controller according to claim 1, further comprising:
a position calculator for calculating an average of the face position information according to a record of the face position information, which is obtained in a predetermined time interval,
wherein the angle calculator calculates the optimum angel of the mirror according to the average of the face position information.

3. The mirror controller according to claim 1,
wherein, after the angle adjuster adjusts the angle of the mirror to be the optimum angle, the controller controls the angle adjuster to adjust the angle of the mirror to be an previous angle when an input device for inputting at least one of a permission instruction of the optimum angle of the mirror and a rejection instruction of the optimum angle of the mirror does note input the permission instruction, or inputs the rejection instruction.

4. The mirror controller according to claim 1,
wherein the controller controls the angle adjuster to adjust the angle of the mirror to be the optimum angle when an input device for inputting at least one of a permission instruction of the optimum angle of the mirror and a rejection instruction of the optimum angle of the mirror inputs the permission instruction, or does not input the rejection instruction.

5. A computer readable storage medium storing a program for causing a computer to execute a process comprising:
providing the face position detector, the angle calculator and the controller, which provide the mirror controller according to claim 1.

6. The mirror controller according to claim 3,
Wherein the previous angle of the mirror, is referred to an angle just before the angle adjuster adjusts the angle of the mirror to be the optimum angle, and
wherein the part of the face is a characteristic point of the face.

7. The mirror controller according to claim 6, further comprising:
a position calculator for calculating an average of the face position information according to a record of the face position information, which is obtained in a predetermined time interval,
wherein the angle calculator calculates the optimum angel of the mirror according to the average off the face position information, and
wherein the average of the face position information is calculated by one of simple moving average weighted moving average and exponential moving average.

8. The mirror controller according to claim 7,
wherein the characteristic point of the face is an eye or a nose of the face, and
wherein the mirror is at least one of aright side mirror, a left side mirror and a rearview mirror of the vehicle.
